(19) United States
(12) Patent Application Publication
(10) Pub. No.: US 2025/0036673 A1
(43) Pub. Date: Jan. 30, 2025

(54) GENERATIVE AI SYSTEMS FOR DOCUMENT-DRIVEN QUESTION ANSWERING

(71) Applicant: Claim Genius, LLC, Las Vegas, NV (US)

(72) Inventors: Sean WEBER, Santa Clarita, CA (US); Shaun MENG, Las Vegas, NV (US); Dalton HOOKS, Las Vegas, NV (US)

(21) Appl. No.: 18/786,249

(22) Filed: Jul. 26, 2024

Related U.S. Application Data
(60) Provisional application No. 63/515,782, filed on Jul. 26, 2023.

(51) Int. Cl. G06F 16/33; G06F 16/332; G06N 3/0475

(52) U.S. Cl. CPC G06F 16/3347; G06F 16/3329; G06N 3/0475

(57) ABSTRACT

Information or documents are generated using generative AI, such as an LLM model. A document set is provided. The document is divided into document fragments. Each fragment is represented as a vector to generate a document vector set. A user inputs a query at a computing device. A prompt is generated from the query and the document vector set. The prompt may include any prior queries and outputs by the model. The prompt is input to the LLM model. The information output is used to generate a document, which is provided back to the user's computing device for output at a display.

### CROSS-REFERENCE TO RELATED APPLICATIONS

This application claims priority to U.S. Provisional App. No. 63/515,782, filed Jul. 26, 2023, and entitled “Generative AI Systems for Document-Driven Question Answering,” the entirety of which is hereby expressly incorporated by reference in its entirety.

### BACKGROUND

Generative AI refers to a category of artificial intelligence (AI) algorithms and models that are designed to generate new, original content or data. Generative AI has been used to create realistic images, generate human-like text, compose music, create virtual characters, and even generate entire scenes or stories.

### SUMMARY

The technology generally relates to a system for interacting with a generative AI model to generate document or produce information derived from a set of documents. The set of documents may be a group of documents pertaining to a specific event, such as a legal dispute, insurance claim, medical records for an individual, or any other document group in other fields.

The document set is divided into document fragments, which can be more easily processed by the model based on its token limitations or other data limitations. Each of the document fragments can be represented by a document vector in the vector space to generate a document vector set representing the document set.

A user provides a query to a computing device. The query requests information that is derived from the document set or a document generated from the document set, such as a legal complaint, medical summary, or the like. A prompt is generated from the received query and the document vector set. The prompt is then provided to the model as an input.

Responsive to the input, the model outputs information that is contextually relevant to the query and includes new content that is derived from the document set based on the document vector set input. The new information may be provided back to the computing device as a response to the input. The input queries and output responses may be saved for use in subsequent queries to maintain contextual outputs based on prior queries. The output information may also be used to generate a document responsive to the query.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology may be employed, in accordance with an aspect described herein;

FIG. 2 illustrates an example process for generating document vectors from document fragments, in accordance with an aspect described herein;

FIG. 3A illustrates an example process of providing a prompt to an LLM model for generating an output, in accordance with an aspect described herein;

FIG. 3B illustrates another example process of providing another prompt to the LLM model for generating another output, in accordance with an aspect described herein;

FIG. 4A illustrates an example fillable document, in accordance with an aspect described herein;

FIG. 4B illustrates an example portion of a document generated from the fillable document of FIG. 4A, in accordance with an aspect described herein;

FIG. 5 illustrates a flow diagram having an example process for implementing aspects of the technology, in accordance with an aspect described herein;

FIG. 6 illustrates a flow diagram having another example process for implementing aspects of the technology, in accordance with an aspect described herein;

FIG. 7 illustrates a flow diagram having another example process for implementing aspects of the technology, in accordance with an aspect described herein;

FIG. 8 illustrates an example computing device in which aspects of the technology can be employed, in accordance with an aspect described herein; and

FIG. 9 illustrates a block diagram having an example method of generating information from a document set using a machine learning model, in accordance with an aspect described herein.

### DETAILED DESCRIPTION

Existing document generation methods are manual, and typically require a person to manually create a document from a large quantity of information described within a document set. This is done in many fields, including medical records, the legal industry, and the insurance industry, along with many others. Typically, this requires distilling large quantities of information into a more structured form.

In existing cases where documents are computer generated, documents are highly structured, and those structures correspond to structured data so that the computer can pull directly from a structured document set and input the information into a corresponding structure data field of a document. A similar event occurs when prompting a computer to recall certain information from a document set. The document set data needs to be in a highly structured order for the computer to identify and recall information satisfying a query. One such example uses a SQL query to query a dataset, recall information, and then insert that information into a corresponding field.

There are several problems with these methods, however. One such problem occurs when the structured document data does not match with a structured field of a document or form that is being generated. In these instances, a query might miss information in the document set or input this information incorrectly into the generated document.

To solve these problems, aspects of the technology train and use large language models (LLMs), such as generative AI models, to generate information from a document set and further generate Documents with information generated from the document set. The technology can be employed in a variety of use cases, such as generating information derived from medical records and drafting medical forms, generating information derived from legal document and drafting legal documents, generating information derived from insurance claims and drafting insurance claim documents, and so forth.

The LLMs help solve the structured data problems previously described. In particular, the LLMs understand further context determined directly from the substance of the data itself. These models can create new output information generated based on the document set. Since the LLM models can understand data context, the methods described herein can work with unstructured Document sets, including those having images, audio, and text. Further, the LLMs can contextually understand Document fields and styles, along with layout and content. As such, it can output information derived from the document set and modify the output as appropriate for generating a Document.

It will be realized that the method previously described is only an example that can be practiced from the description that follows, and it is provided to more easily understand the technology and recognize its benefits. Additional examples are now described with reference to the figures.

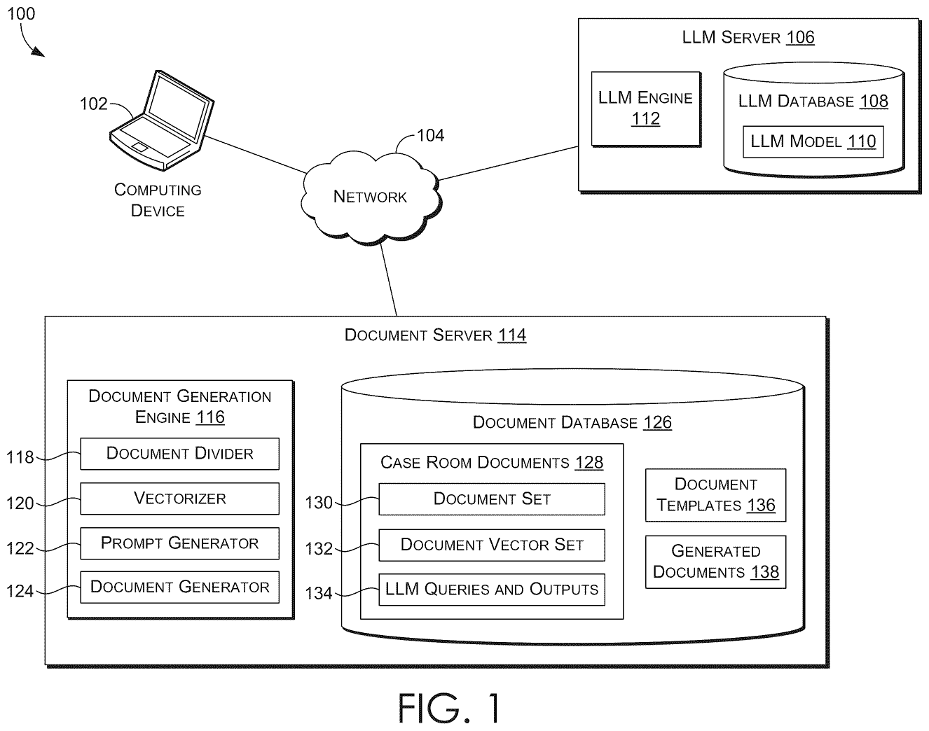

With reference now to FIG. 1, an example operating environment 100 in which aspects of the technology may be employed is provided. Among other components or engines not shown, operating environment 100 comprises computing device 102, in communication via network 104 with LLM server 106 and document server 114.

Network 104 may include one or more networks (e.g., public network or virtual private network [VPN]), as shown with network 104. Network 104 may include, without limitation, one or more local area networks (LANs), wide area networks (WANs), or any other communication network or method.

It is noted and emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to document generation engine 116 and those executed by LLM server 106, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as LLM database 108 and document database 126. Moreover, functions of document generation engine 116 or other functions described in the disclosure may be performed by computing device 102, LLM server 106, document server 114, or any other component, and in any combination. Thus, it will be realized that in other suitable operating environment arrangements, functions may be executed in various combinations, orders, and devices. Thus, for the sake of example, while document generation engine 116 is shown as executed by document server 114, some of these functions could be executed by computing device 102 or LLM server 106. Likewise, functions that will be described as performed by LLM engine 112 of LLM server 106 may be performed by computing device 102 or document server 114, and so forth.

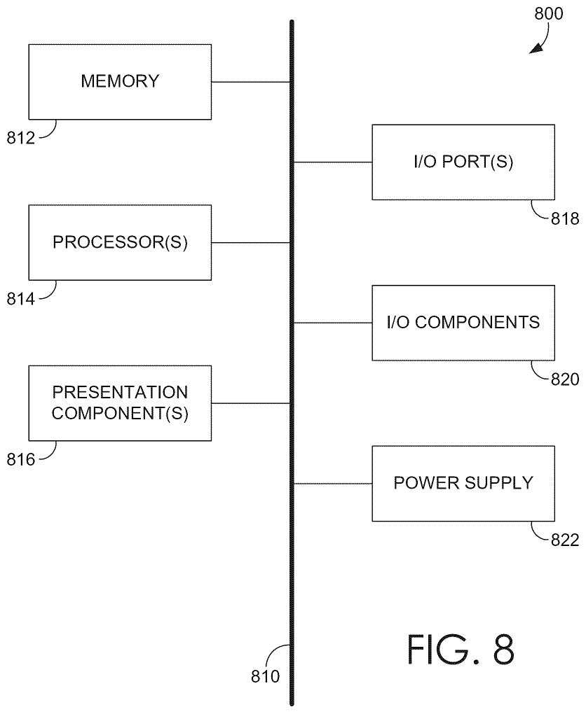

Continuing with the example illustrated in FIG. 1, computing device 102 generally communicates with document server 114 to input information and receive outputs. As with other components of FIG. 1, computing device 102 is intended to represent one or more computing devices. One suitable example of a computing device that can be employed as computing device 102 is described as computing device 800 with respect to FIG. 8. In implementations, computing device 102 is a client-side or front-end device.

A user can use computing device 102 to input a document set. A document set may comprise one or more documents that relate to an event. For instance, in the context of using the technology to generate a legal document, the document set can include all of the documents related to a single case. These documents may be combined into a single file or stored as multiple files. In some cases, document sets may comprise hundreds or thousands of pages, although all size document sets are contemplated.

In an aspect, computing device 102 may be used by a user to input queries that request information derived from a document set, such as requesting contextually relevant information responsive to the a query, or requesting generation of a document responsive to the query and comprising the contextually relevant information. Such information or documents may be received by computing device 102 and rendered at a display device for providing to a user.

Documents in a document set may comprise any form of document. These include text, image, and audio-based files. Some example documents intended to be within the scope of document that may be found in the document set provided as DC/DOCX, PDF (Portable Document Format), XLS/XLSX, CSV (Comma Separated Values), TXT (Plain text file); RTF (Rich Text Format), PPT/PPTX, ODT, ODS, HTML (Hyper Text Markup Language), JSON (JavaScript Object Notation); XML (eXtensible Markup Language), MP4 (MPEG-4), MOV, WMV (Windows Media Video), AVI (Audio Video Interleaved), MP3 (MPEG-3), AAC (Advanced Audio Coding), WMA (Windows Media Audio), and so forth.

In general, document server 114 receives information from computing device 102, such as a document set, and generates outputs or documents with information derived from the document set. It does so, for example, by communicating with LLM server 106 to employ LLM model 110 to derive the information.

Referring briefly to LLM server 106, LLM server 106 generally employs LLM engine 112. LLM engine 112 accesses LLM model 110 stored in LLM database 108 to receive inputs, such as prompts and generate outputs by providing the prompts to LLM model 110, which generates an output in accordance with its training.

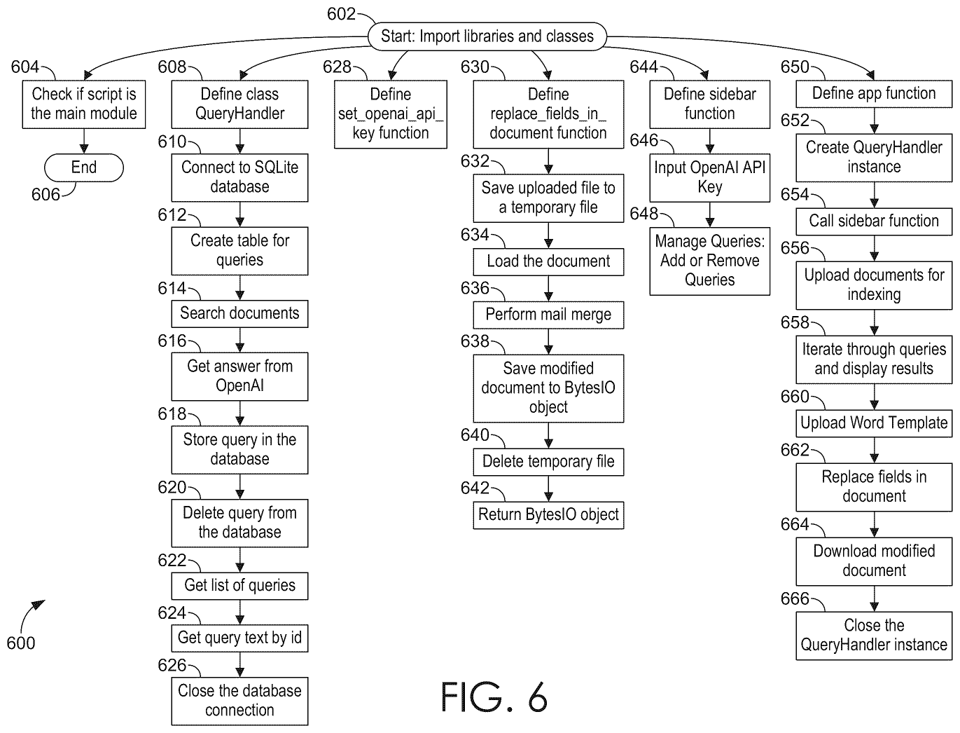

LLM database 108 generally stores information, including data, computer instructions (e.g., software program instructions, routines, or services), or models used in embodiments of the described technologies. For instance, such stored information may be used by LLM engine 112. Although depicted as a single database component, LLM database 108 may be embodied as one or more databases or may be in the cloud. In aspects, LLM database 108 is representative of a distributed ledger network. While illustrated as part of LLM server 106, in another configuration, LLM database 108 is remote from LLM server 106. In connection with FIG. 6, memory 612 describes some example hardware suitable for use as LLM database 108.

LLM model 110 may comprise a generative AI model. Generative AI starts with a prompt that could be in the form of text, images, videos, or audio, or any input that LLM model 110 can process based on its training and model configuration. LLM model 110 then generates and returns new content in response to the prompt. In general, LLMs are advanced machine learning models that can understand natural language inputs and provide contextually relevant natural language outputs. Content can include a myriad of contextual information, which are responsive to the inputs, such as prompts or other information, such as a document set. Some example outputs include contextually relevant text, solutions to problems, or realistic images or audio. Some example generative AI models that are LLMs and may be suitable for use with the current technology include ChatGPT, Bard, DALL-E, Midjourney, DeepMind, and the like. LLM model 110 may be a single LLM model or may be multiple models working in coordination to generate an output.

LLM model 110 can be trained so that it outputs a response in accordance with its training. During training, the model learns to predict a target output (like the next word in a sequence or masked word) based on input vectors. The “knowledge” of the model is encoded in the weights that define how it transforms and combines the input vectors to make its prediction.

As an example, one suitable model for LLM model 110 comprises a transformer architecture, having an encoder to process an input, and a decoder to process the output, e.g., a generative pre-trained transformer. The model can be pre-trained using a large document corpus. Some commonly used textual datasets are Common Crawl, The Pile, MassiveText, Wikipedia, and GitHub. The datasets may run up to 10 trillion words in size. The text can be split into tokens, e.g., words or characters. The transformer architecture can then be trained to predict the next token in a sequence based on the training data. For instance, this may be done via backpropagation, which calculates the gradient of the loss with respect to the model parameters, and an optimization algorithm, which adjusts the parameters to minimize the loss. The Adam optimization algorithm may be used for this process.

The pre-trained model can be fine-tuned using supervised learning. Here, a dataset is generated with input-output pairs that are known. For natural language processing, word and sentence structures can be used as the dataset, providing a natural language input and a known appropriate response. In some cases, a dataset corresponding to a field of a document set for which the model is used may be suitable for fine tuning the model. That is, if the model is to be used to draft legal documents, fine-tuning may be done using a corpus of legal documents, and likewise for other fields. The fine-tuned model may then be subject to further optimization processes and provided for use as LLM model 110.

One example training process suitable for training LLM model 110 is described in Training Language Models to Following Instructions with Human Feedback, Long Ouyang, et al., 4 Mar. 2022, available at https://doi.org/10.48550/arXiv.2203.02155, which is hereby expressly incorporated by reference in its entirety.

Having trained LLM model 110, LLM model 110 is stored at LLM database 108 for use by LLM engine 112 when employed by LLM server 106. Document server 114, in the illustrated example, communicates with LLM server 106 to provide prompts, e.g., inputs to LLM model 110, and receive outputs for use by document generation engine 116 in generating information or documents that are provided to computing device 102, as will be further described.

At a high level, document server 114 is a computing device that implements functional aspects of operating environment 100, such as one or more functions of document generation engine 116 to generate information or documents and provide them to computing device 102. One suitable example of a computing device that can be employed as document server 114 is described as computing device 800 with respect to FIG. 8. In implementations, document server 114 represents a back-end or server-side device.

Components of document server 114 may interface with components of LLM server 106 to perform certain functions. Generally, LLM server 106 is a computing device that implements functional aspects of operating environment 100, such as one or more functions of LLM engine 112, to receive inputs and output contextually relevant information by employing LLM model 110. This can be utilized by components of document server 114 to generate contextually relevant information from a document set and generate documents using such information. One suitable example of a computing device that can be employed as LLM server 106 is described as computing device 800 with respect to FIG. 8. In implementations, LLM server 106 represents a back-end or server-side device.

While document server 114 and LLM server 106 are illustrated as separate servers employing separate engines, in other aspects of the invention one or more servers may be used to implement the described functionality.

To generate contextually relevant information derived from a document set, document server 114 may employ document generation engine 116. In the example illustrated, document generation engine 116 comprises document divider 118, vectorizer 120, prompt generator 122, and document generator 124. These components may access or otherwise store information within document database 126.

Document database 126 generally stores information, including data, computer instructions (e.g., software program instructions, routines, or services), or models used in embodiments of the described technologies. For instance, such stored information may be used by document generation engine 116. Although depicted as a single database component, document database 126 may be embodied as one or more databases or may be in the cloud. In aspects, document database 126 is representative of a distributed ledger network. While illustrated as part of document server 114, in another configuration, document database 126 is remote from document server 114. In connection with FIG. 6, memory 612 describes some example hardware suitable for use as document database 126.

In some aspects of the technology, document server 114 provides case room features to computing device 102. In doing so, documents pertaining to a specific event may be associated with one another. A user may access a case room, and in doing so, document generation engine 116 of document server 114 may access case room documents 128, which are documents corresponding to the specific event. As an example, in a legal use case, the case room documents may be grouped based on a single case. In an insurance use case, specific documents may be group based on a single claim. Some of these documents may include the document set, such as document set 130, as well as LLM queries and outputs, such as LLM queries and outputs 134, as will be further described.

In general, document generation engine 116 can generate contextually relevant information from a document set, such as document set 130. In aspects, the information generated by document generation engine 116 is provided to computing device 102 or may be used to generate a document, which may be provided to computing device 102.

To do so, document set 130, having been received from computing device 102 and stored in document database 126, may be accessed and divided into a plurality of document fragments using document divider 118.

In an implementation, document divider 118 is configured to divide document set 130 into a plurality of document fragments using a recursive character text splitter. A recursive character text splitter is a function or algorithm that uses recursion to divide a given text string into smaller units based on certain conditions or delimiters, such as spaces, commas, or other characters. Recursive splitting can be used to parse sentences, identify grammatical structures, or handle nested structures in text data.

In an aspect, document set 130 is subject to OCR (optical character recognition) to determine text within the document. Audio and video may be provided in their native audio or video formats, or may be transcribed to text and divided using document divider 118.

In some cases, the document division is based on a limitation of LLM model 110. While LLM model 110 will be further described, some LLM models that are suitable are computationally expensive to employ, meaning they use large amounts of computing resources. As such, some LLM models, such as commonly used generative AI models like ChatGPT, have a token limitation. Thus, document divider 118 may divide document set 130 into a plurality of document fragments based on the token limitation of LLM model 110.

For example, in the context of using generative AI, such as ChatGPT, tokens refer to the units into which the input text is divided for processing. In natural language processing (NLP), a token can represent a single character or a word, depending on the granularity chosen.

To provide an example, consider the sentence: “I love ice cream.” In a character-level tokenization, each character (including spaces) would be treated as a separate token: [‘I’, ‘ ’, ‘l’, ‘o’, ‘v’, ‘e’, ‘ ’, ‘i’, ‘c’, ‘e’, ‘ ’, ‘c’, ‘r’, ‘e’, ‘a’, ‘m’, ‘.’]. In a word-level tokenization, each word would be treated as a separate token: [′I′, ‘love’, ‘ice’, ‘cream’, ‘.’].

Generative AI models like ChatGPT have a maximum limit on the number of tokens they can process in one go. For instance, at the time of drafting this disclosure, the token limit for gpt-35-turbo is 4096 tokens, whereas the token limits for gpt-4 and gpt-4-32k are 8192 and 32768, respectively. These limits include the token count from both the message array sent and the model response. If the input text exceeds this limit, it needs to be truncated or split into smaller chunks to fit within the model's capacity.

Thus, based on identifying the token limit for the particular model being employed as LLM model 110, document divider 118 splits document set 130 into the plurality of document fragments. In doing so, each fragment may comprise less than the total token limitation, such as the limitation of characters or words determined by the token limitation.

In some cases, document divider 118 identifies the document fragments based on delimiters. That is, document divider 118 may use recursive character text splitting to identify a specific delimiter before a threshold number of characters or words, e.g., a threshold corresponding to a token capacity of LLM model 110, or other determined or received threshold value. In this way, document divider 118 may reduce the chance that text is divided between document fragments in a manner that reduces the context of the divided text. For instance, the delimiter chosen may be a period, paragraph return, section heading, page break, and so forth. This aids in keeping contextually similar text grouped within each document fragment.

In some aspects, document divider 118 divides document set 130 into document fragments based on a data size of the fragment. For example, a threshold data size value may be determined or otherwise received. Document divider 118 may divide document set 130 such that each document fragment has a data size equal to or less than the threshold data size. For instance, this may be done to identify and provide document fragments (or vectors thereof, as will be described) to LLMs that may receive image, audio, or video, while it also may be suitable for text-based document sets as well. Any threshold data value may be used, although some examples could include 50 KB (kilobytes), 100 kB, 250 KB, 500 KB, 1 MB (megabyte), 50 MB, 100 MB, 500 MB, 1 GB (gigabyte), 5 GB, 10 GB, 50 GB, and so forth.

In some aspects, document divider 118 divides document set 130 by content. In such cases, each document fragment is divided so that each document fragment includes related content. That is, the content in a document fragment is all related to a same subject. For example, this may be done by dividing document set 130 based on pages, file type, section headings, or other like subject matter delimiters.

Having divided the document into a plurality of document fragments, the document fragments can be represented as a vector using vectorizer 120. A document vector is a mathematical or computational structure that comprises of an ordered list of numbers. Thus, each document fragment is represented as a point in a multidimensional vector space, and each dimension corresponds to a feature derived from text (such as a specific word or phrase), images, audio, or video within the document fragment.

Vectorizer 120 may utilize a vectorizing algorithm. Some examples that may be suitable for use include Bag of Words (BoW), TF-IDF (Term Frequency-Inverse Document Frequency), and Doc2Vec. The document vectors can be used to identify similarity between document fragments, classify or cluster document fragments, or serve as input to machine learning models, such as LLM model 110, as will be further described, among other uses.

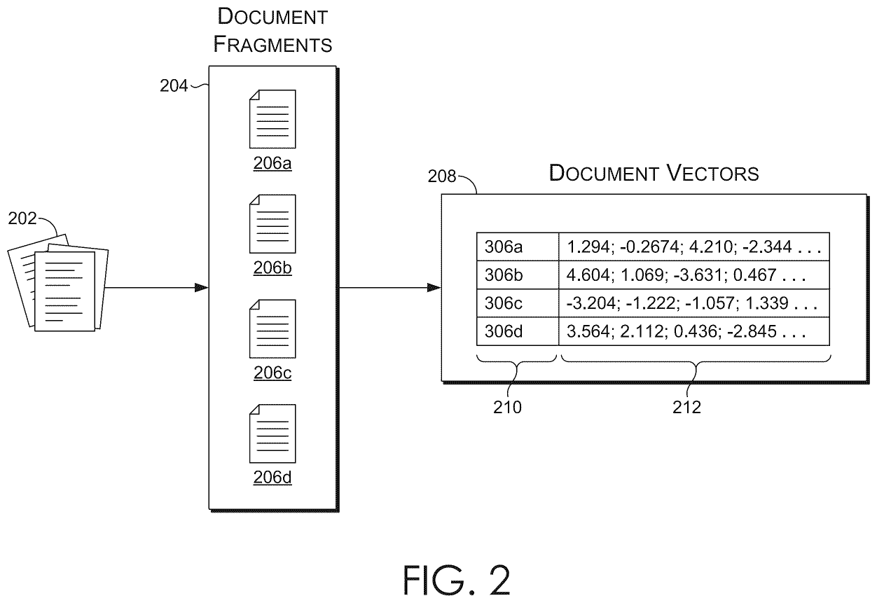

FIG. 2 illustrates a process performed by document divider 118 and vectorizer 120. Here, document set 202 may be a document set such as those previously described, and may contain one or more pages of documents of one or more file types. Document set 202 may be a text only document, or may include other forms of media, such as images, audio, or video.

Document set 202 is provided to document divider 118, which divides document set 202 into document fragments 204. Document fragments 204 comprise a plurality of document fragments that includes document fragment 206a, document fragment 206b, document fragment 206c, and document fragment 206d. While illustrated as four document fragments, it is contemplated that document fragments 204 could include any number of document fragments within the plurality of document fragments.

Each document fragment of document fragments 204 is provided to vectorizer 120, which generates document vectors 208. In this example, an index that includes document fragment ID 210 corresponding to each document fragment of document fragments 204 is shown in respective association with corresponding document vectors of document vector set 212. It will be realized that document vectors 208 may be represented or stored in other forms that can be accessed by a computing device, and the on illustrated with respect to FIG. 2 is only one example. Document vectors 208 may be stored for future use by computing devices, such as storing document vectors in document database 126 for use by LLM server 106 and components thereof. For example, vectors representing document fragments generated from document set 130 are stored in case room documents 128 as document vector set 132.

Prompt generator 122 generally generates a prompt for prompting LLM server 106. The prompt is provided to LLM model 110 by LLM engine 112 to generate an output, which is received by document server 114. As will be described, the information generated by LLM engine 112 may be new content that is derived based on document set 130.

Prompts may include any natural language text string with information or a request for information. Depending on the LLM model 110, a prompt may also include other media, such as images, video, or audio. Some prompts may include requests for document generation.

Prompts generated by prompt generator 122 can include queries received from computing device 102. That is, a user can input a query at computing device 102, which can include any natural language query with a request for information or document generation. Queries received from computing device 102 may also include images, video, or audio in some cases. Queries from computing device 102 may comprise a document set identifier, such as a case number, claim number, or other type of identifier. In an aspect, the document set identifier may be based on the user inputting the query in a case room. This identifier may be used by prompt generator 122 to identify case room documents 128, including document set 130, document vector set 132, LLM queries and outputs 134, or other case room-related documents.

When generating an output responsive to a prompt, LLM engine 112 may provide a document set, or vectors thereof, to LLM model 110, which generates and provides an output based on the document set. That is, the content generated as part of the output may be contextually relevant to the query provided in the prompt and derived from the document set, such as document set 130. In this way, prompts may include queries that request information that is derived from a document set, such as summaries of the document set, questions related to the content of the document set, and so forth. LLM model 110 processes the prompt to determine the natural language context and may provide a natural language output satisfying the prompt using the information derived from the document set. Thus, for instance, prompt generator 122 may receive a query from computing device 102, generate a prompt having the query along with document vector set 132 (which corresponds to the vectors of the document set identified in relation to the query), and provide a prompt to LLM server 106 for processing by LLM engine 112. The output responsive to the prompt may be provided by LLM server 106 and received by document server 114.

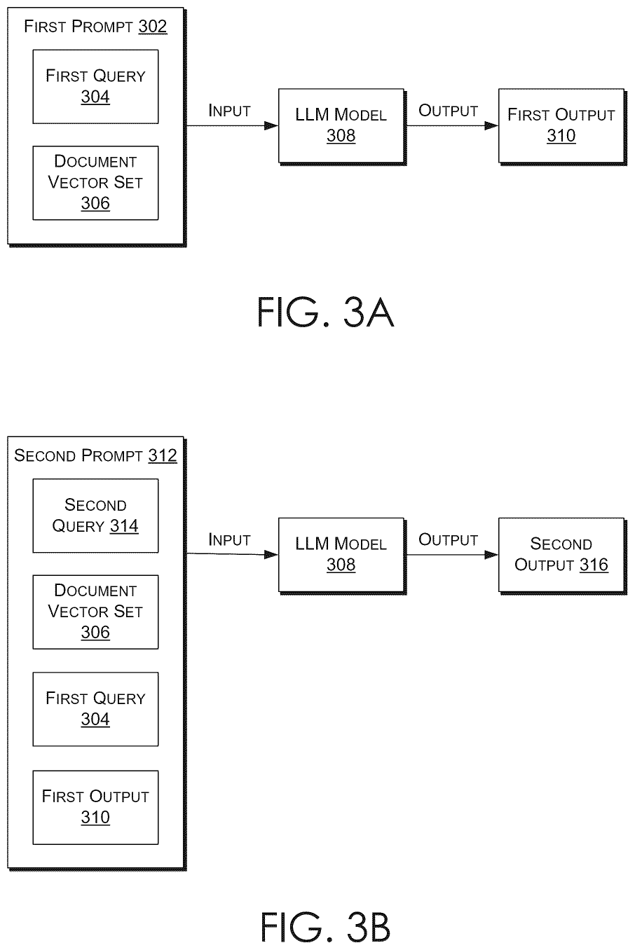

FIG. 3A illustrates an example prompt that may be generated by prompt generator 122. Here, first prompt 302 comprises first query 304, which may be received from a computing device, such as computing device 102. First prompt 302 further comprises document vector set 306, which includes a set of vectors that each correspond to a document fragment generated from a document set, as was described with reference to document divider 118 and vectorizer 120. First prompt 302 is provided as an input to LLM model 308. LLM model 110 is an example usable as LLM model 308. In response, LLM model 308 provides as a first output 310, which is responsive to first query 304 and comprises information contextually relevant to first query 304, as derived from a document set from which document vector set 306 was generated. In some cases, first prompt 302, or components thereof, such as the query, and the first output 310 may be stored for later use by components of document generation engine 116. For instance, these may be stored in document database 126 as part of LLM queries and outputs 134.

A user may provide subsequent queries related to the same document set, e.g., by using a case room or identifying the document set in another particular manner. In doing so, the response to the query may be derived from the document set, such as document set 130, in addition to being responsive to the context of previous queries and outputs, such as those generated and illustrated in FIG. 3A. That is, some LLM models suitable for use as LLM model 110 not only provide contextually relevant responses to a query, but also do so in the context of prior queries and prior outputs. This versatility reduces the number of inputs a user has to provide for the model to understand the contextual relevance of the query. It allows the user to provide inputs that are more akin to a more natural language discussion.

FIG. 3B illustrates an example of another prompt generated by prompt generator 122 in this manner. In this example, second prompt 312 comprises second query 314, which is received from a computing device, such as computing device 102. In an aspect, second prompt 312 is a prompt subsequent to first prompt 302. It may be a request for information or to generate a document in which context is needed from a prior prompt to output a contextually relevant response. As such, second prompt 312 may relate to the same document set as first prompt 302, and therefore second prompt 312 further comprises document vector set 306. So that LLM model 308 can provide an output based on a prior query, second prompt 312 also comprises first query 304 and first output 310.

Having received second prompt 312 as an input, LLM model 308 outputs second output 316. Second output 316 is responsive to second query 314 and provides contextually relevant information derived from the document set and the prior queries and outputs, such as first query 304 and first output 310. It will be realized that any number of prior queries and outputs may be provided to LLM model 308. In doing so, LLM model 308 can provide outputs having information derived from a document set with the context of any prior queries and outputs related to the document set.

In an aspect, a query received by computing device 102 requests information derived from document set 130. In such cases, once the output is received from LLM server 106, the output may be provided by document server 114 to computing device 102 as a response to the query. In other cases, the information may be used to generate a document.

To generate a document, document generation engine 116 may employ document generator 124. In general, document generator 124 generates a document based on information received from LLM server 106, responsive to a prompt.

In one example method, document generator 124 uses a document template to generate a document. The document template may be accessed from document templates 136 stored in document database 126. In some cases, a document template comprises fields. Each field is a location where text or images may be inserted to include the document generated using the document template. In some cases, a field has a corresponding descriptor that identifies the content that should be placed into the field. Put another way, the descriptor describes the input to the field.

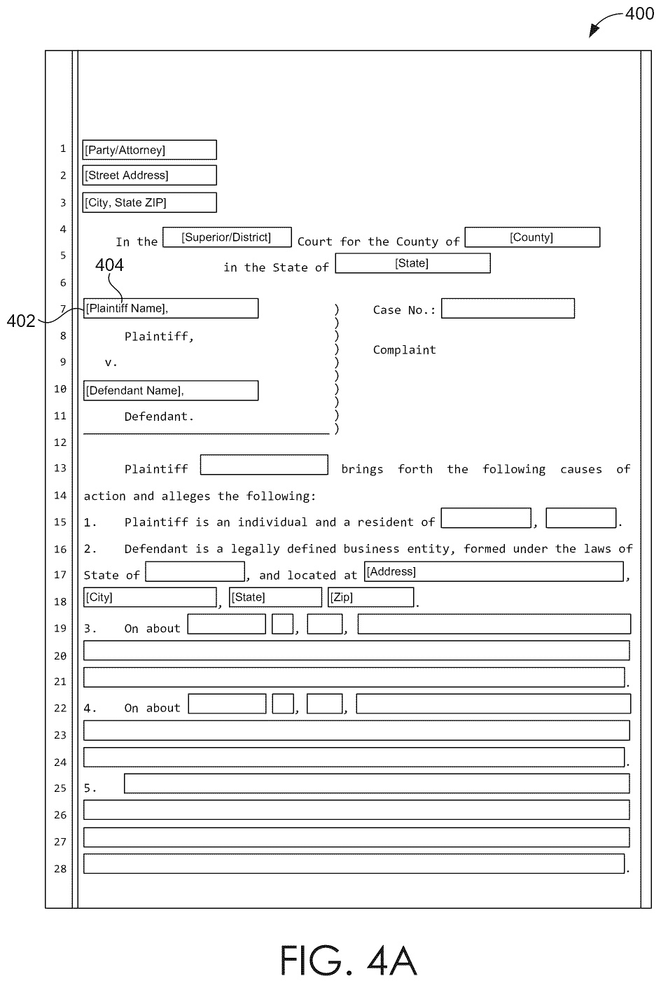

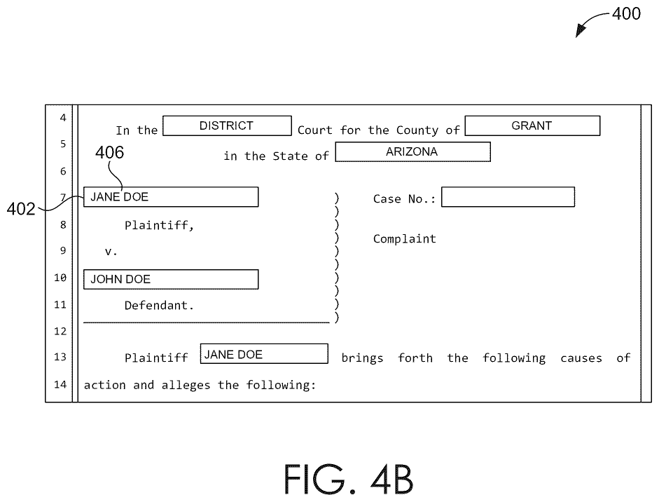

FIG. 4A illustrates an example document template 400. This particular example is for a legal complaint. It includes various text fields, along with their corresponding descriptors indicating the information to be placed within each field. One example is document template field 402, which has a corresponding descriptor 404 identifying the information to input into field 402 when generating a document from document template 400.

In an example case, to generate a document, a descriptor may serve as a query to include within a prompt generated by prompt generator 122. The prompt may comprise further queries from a computing device, document vectors, or any other prior queries and outputs related to a document set for which information is derived when generating the document.

The prompt may be provided for input to a model, such as LLM model 110. The output provided by the model is inserted into the field corresponding to the query to generate the document. FIG. 4B illustrates an example of document template 400 of FIG. 4A having outputs from a model inserted into fields to generate a document. One example illustrated includes field 402 and output 406, which has been inserted into field 402.

It will be understood that this is one example method in which a document may be generated using the technology. In another aspect, an LLM model, such as LLM model 110, is trained on documents of a same document type for which there is a request to generate. Thus, as an example, an LLM model may be trained using a dataset that comprises legal documents, including complaints, that have been indicated as such within the training data. Based on this, the model may generate documents of the same document type. The generated document may have new content generated by the LLM to complete the generated document, where the new content is derived from a document set. The document may be generated in response to a query from a computing device, and a prompt comprising the query and a document vector set is input to the model. The generated document may be provided to the computing device and rendered at a display.

Generated documents may be stored for future use. As illustrated in FIG. 1, a document generated using document generator 124 may be stored as generated documents 138.

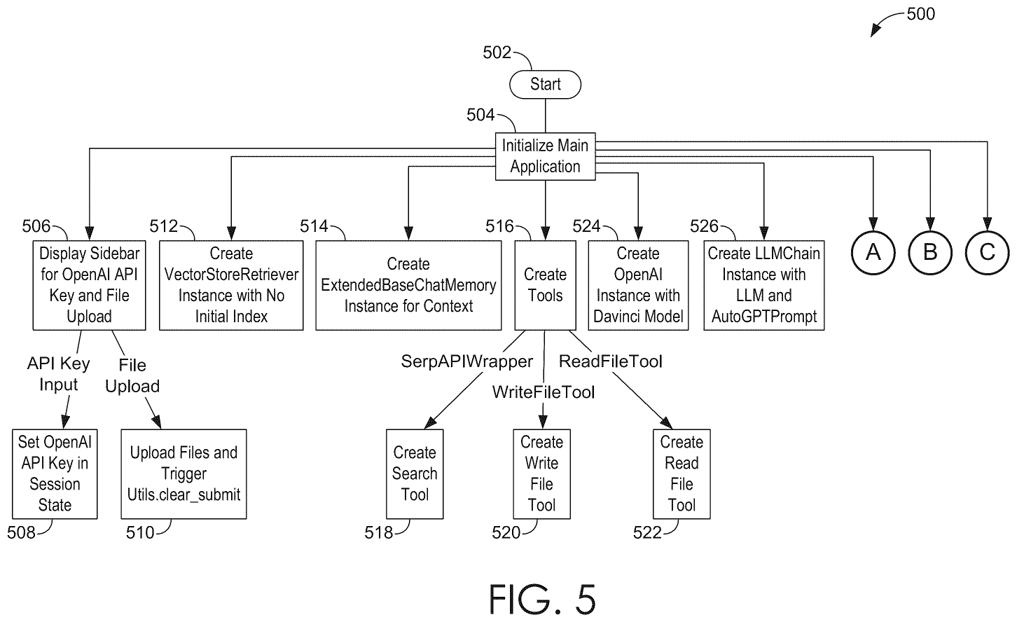

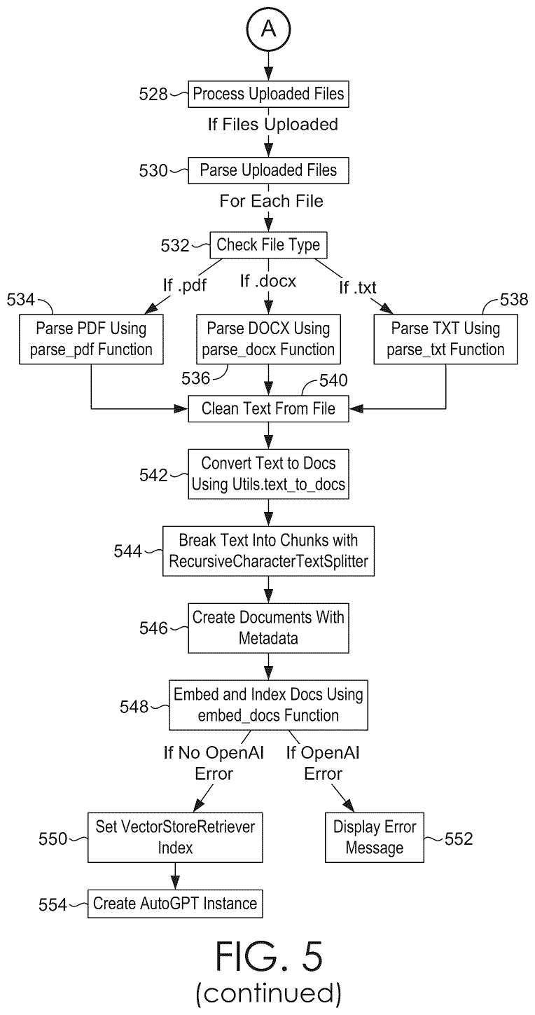

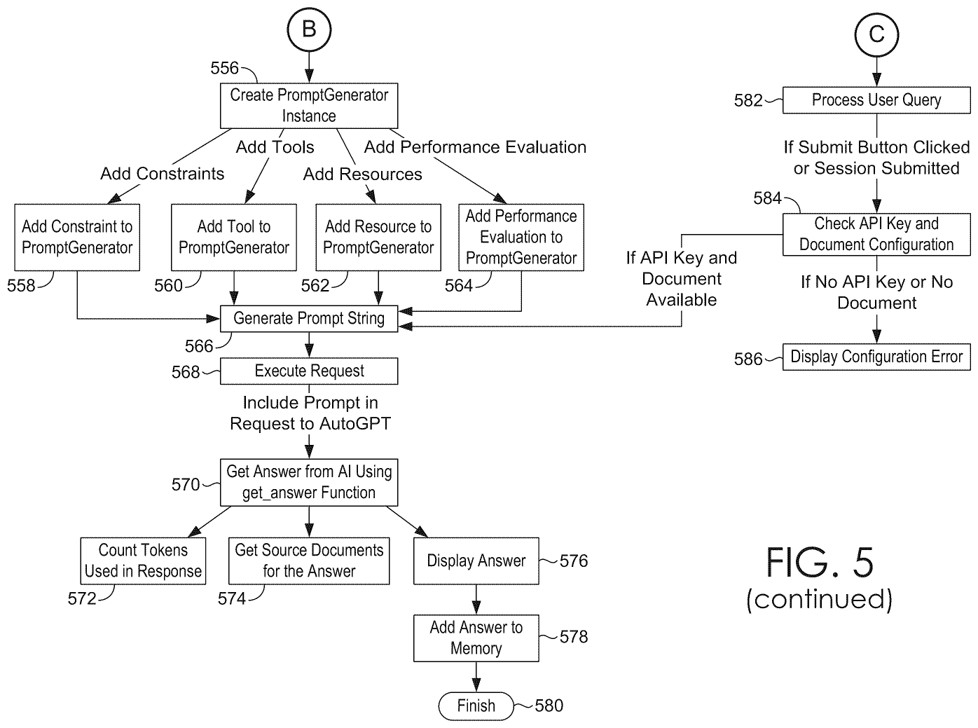

Turning now to FIG. 5, flow diagram 500 having an example process for implementing aspects of the technology is provided. As will be understood from further discussion, flow diagram 500 is illustrated with reference numerals to aid in describing the process. The order of the reference numerals is not intended to impart any particular order or sequence of the process. The illustration in FIG. 5 is an example, and it will be realized by those of ordinary skill in the art that other processes having more or fewer operations can be performed from the described technology, just as those operations in FIG. 5 may depart from the order in which they are illustrated in some aspects of the technology.

Having this in mind, flow diagram 500 starts at block 502 and proceeds to initialize an application at block 504. In generation, an application is a software program that comprises instructions for performing one or more of the operations described throughout this disclosure. The application may be stored locally at a computing device, such as computing device 102, or may be remote from computing device 102, or may comprise one or more applications that are local, remote, or both.

Upon initializing the application at block 504, user interface elements may be rendered and displayed at a computing device. At block 506, an interface element that permits upload of a document set to a server, such as document server 114. Here, this is illustrated as displaying a sidebar for an API permitting key or file uploading. If a selection is made for an API key input, for instance, that identifies a case room or other document set identifier, then at block 508, an API session is opened at block 508 corresponding to the API key input. If a selection is made to upload a file, a file is uploaded and submitted at block 510.

At block 512, document vectors are retrieved. At block 514, a chat memory is created. This may include saving queries and outputs as previously described. The queries and outputs may be grouped or otherwise saved with respect to a particular document set, e.g., a case room where subsequent queries, which continue from prior queries and outputs, can be generated for the document set.

At block 516, application tools are created or otherwise initialized. Some example application tools include a search tool at block 518, a write file tool at block 520, and a read file tool at block 522. These tools provide the user with various functionalities, including the ability to search for document sets and other information related to the document set, such as prior queries and responses, the ability to create new document sets or case rooms for document sets; or accessing a document set; respectively, and the like.

At block 524, a communication link with an LLM server is established. At block 526, an initial prompt to the LLM server is provided to initiate a message thread with an LLM model.

At block 528, files are uploaded. For instance, this may be a document set. These may be uploaded at the computing device via the user interface. At block 530, the uploaded file is parsed, and at block 532, the parsed file or the document set is checked to determine a file type. Based on the file type, various functions may be used to parse the document. For example, if the document is a PDF, a PDF parsing function is used at block 534; if the document is a DOCX file, a DOCX parsing function is used at block 536; if the document is a text document (TXT), a TXT parsing function may be used at block 538; and so forth, based on the file type.

The parsed document is cleaned at block 540. For instance, duplicate documents may be removed. OCR (optical character recognition) may be applied to the document to determine characters and words present in the document. Irrelevant documentation may be removed.

Moreover, some file types may be converted into another type of file for vectorization, which may be dependent on input requirements for the algorithm vectorizing the document. In one example, at block 542, files (e.g., the document set) are converted to DOCX files.

At block 542, the document set is divided into document fragments. This can be done using recursive character text splitting, as described. At block 546, the document fragments are created based on the division determined at block 544, and the document fragments are tagged with metadata to indicate the portion of the document set from which the document fragments were divided. They may be tagged with an identifier identifying the document fragment or document set, among other metadata. The document fragments may be indexed at block 548.

At block 550, vectors are generated for each document fragment. These may be provided to an LLM model at block 554. If there is an error with the LLM server 106, then an error message may be displayed at the computing device, illustrated in block 552.

A prompt is generated at block 556. The prompt may include a query related to the document set that is received from the computing device. The query may further comprise the document vector set. Various other instances may be added when generating the prompt. Some examples include constraints at block 558, tools at block 560, resources at block 562, and performance evaluation at block 564. From these, a prompt string is generated at block 566, and the request is executed at block 568, e.g., by communicating the generated prompt string to an LLM server, such as LLM server 106.

Responsive to communicating the prompt at block 568, an output is received from the model at block 570. Tokens corresponding to the model capability are counted at block 572. Where the answer reference source documents, e.g., from the document set, the source documents may be retrieved at block 574. Source documents may be retrieved by identifying them via the index. Other documents may be retrieved from a datastore or via a network, such as an intranet or the Internet. At block 576, the output is communicated to the computing device as the answer, where the computing device displays the answer in response. The output (e.g., the answer) may be stored for future use, such as being included in subsequent prompts, at block 578. The process finishes at block 580.

As noted, a user query may be included in the prompt. At block 582, a user query is received and processed. The API key and document configuration are checked at block 584. For instance, it may be determined whether the query is associated with a particular document set. If the API is open and the document set is available, the query is included in the prompt at block 566. If API communication is not established with the model server, an error message may be displayed at block 586.

Turning now to FIG. 6, flow diagram 600 having an example process for implementing aspects of the technology is provided. As will be understood from further discussion, flow diagram 600 is illustrated with reference numerals to aid in describing the process. The order of the reference numerals is not intended to impart any particular order or sequence of the process. The illustration in FIG. 6 is an example, and it will be realized by those of ordinary skill in the art that other processes having more or fewer operations can be performed from the described technology, just as those operations in FIG. 6 may depart from the order in which they are illustrated in some aspects of the technology.

Flow diagram 600 starts at block 602 and proceeds to import libraries and classes. The script begins by importing necessary libraries and classes that are essential for its functionality. At block 604, the script is checked to determine whether it is a main module. At block 606, the process ends.

At block 608, a class is defined. For example, the A class is defined and named QueryHandler. At block 610, the process proceeds to connect to the SQLite Database. This established a connection to a SQLite database. At block 612, a table is created for queries. This may provide an indexable data structure for which to store queries such that they can be recalled. At block 614, documents are searched. This may include a document set. A document set may be recalled. At block 616, an answer is received from a generative AI model. For instance, a prompt and document set may be provided to the AI model, and an answer received. In aspects, an API connection is established with an AI model system for communicating the prompt and receiving the answer from the model. At block 618, the query is stored in the database. This may be the indexable data structure generated at block 612, for example. The query may be stored for future use when providing prompts to the AI model. At block 620, a query may be deleted from the database. At block 622, a list of queries is retrieved. The list of queries may be retried from the database. At block 624, a query is recalled from the database. This may be done based on the list of queries. One or more previously stored queries may be retrieved. This may be done by retrieving the one or more queries using query IDs mapped to the stored queries in the index. At block 626, the database connection is closed. This may close the connection to the SQLite database.

At block 628, a function is defined. The function sets an API connection to an AI model. This may define a function to set the API key for the AI model system, such as OpenAI.

At block 630, a function is defined. The function defined replaces fields in documents to generate a document. The function may be defined “replace_fields_in_document.” A document may be modified using techniques described throughout. At block 632, an uploaded file is saved to a temporary data store. At block 634, the document is loaded from the temporary datastore. At block 636, mail merger operations are performed on the loaded document. At block 638, a modified document is saved. This may be saved to a BytesIO object (in-memory file). At block 640, the temporary file is deleted. At block 642, the process returns the BytesIO object with the modified document.

At block 644, a function is defined. This may be named a sidebar function. At block 646, the process takes the defined API key as an input. Queries in the datastore may be managed. Users may add or remove queries that may be used as part of prompts for the AI model.

At block 650, an app function is defined. In an example setup, this is the main function where application logic is executed. At block 652, an instance of a the class defined at block 608 is created. In this example, the QueryHandler class is created. At block 654, the sidebar function defined at block 644 is called. At block, 656, the user uploads documents (e.g., a document set) that for indexing. At block 658, the process loops through the queries and displays the results. At block 660, a document template is uploaded. This may be a document template with fillable fields as previously described. At block, 662, fields are replaced in the document. At block 664, the modified document, having the inputs to the fields, is downloaded. At block 666, the QueryHandler, or other named class, is closed.

In some aspects, the process further includes checking to determine whether scripts is being run as a main module, and if so, the script executes the main function application, e.g., the app function. The process then ends.

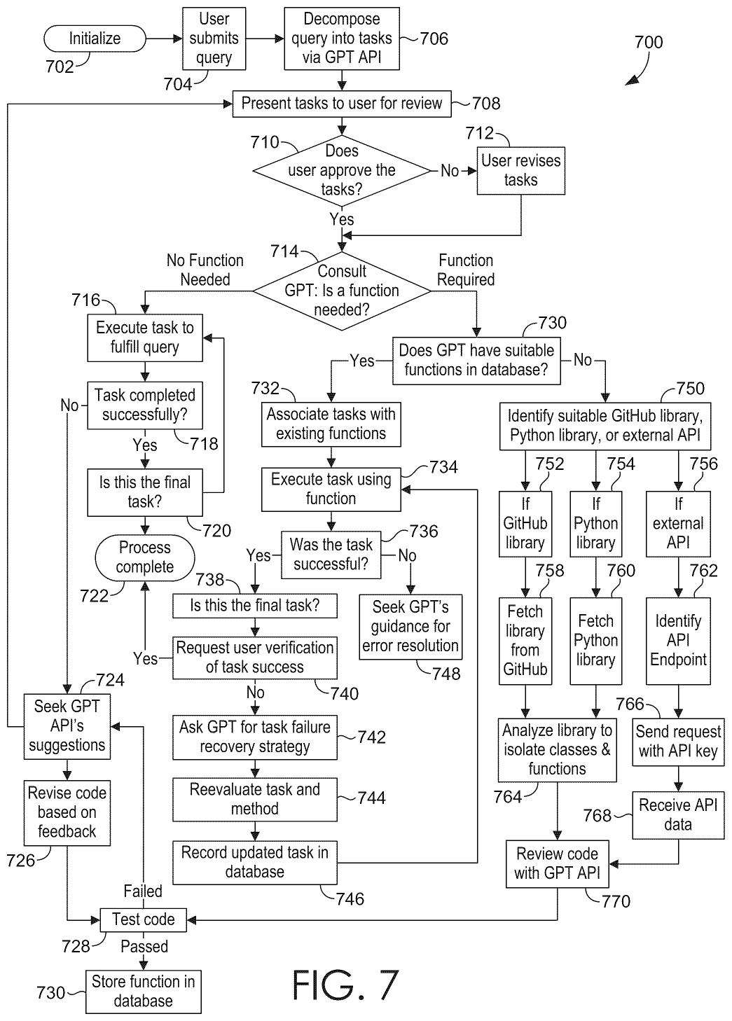

Turning now to FIG. 7, flow diagram 700 having an example process for implementing aspects of the technology is provided. As will be understood from further discussion, flow diagram 700 is illustrated with reference numerals to aid in describing the process. The order of the reference numerals is not intended to impart any particular order or sequence of the process. The illustration in FIG. 7 is an example, and it will be realized by those of ordinary skill in the art that other processes having more or fewer operations can be performed from the described technology, just as those operations in FIG. 7 may depart from the order in which they are illustrated in some aspects of the technology.

Flow diagram 700 starts at block 702 and initializes. At block 704, a query is received from a user computing device. At block 706, the query is decomposed into tasks via a generative AI model through, e.g., an API connection. A block 708, tasks are displayed. These may be presented to a user for review. At block 710, it may be determined whether the tasks at block 708 were approved. If not approved the process proceeds to block 712 where the revised tasks are received. If the tasks or revised tasks are approved. The process proceeds to block 714, and it is determined whether a function is needed for the generative AI model.

If a function is not required, the process proceeds to block 716 where a task is executed to fulfil the query. At block 718, it is determined whether the task was completed successfully. If not, then suggestions are determined from the generative AI model, and the process proceeds back to block 708 where tasks, including those suggested, are presented back to the user for review. If yes, then it is determined whether the task was a final task at block 720. If not, the process proceeds back to block 716, where another task is executed to fulfill the query. If yes, then the process is completed.

In the example illustrated, after seeking the AI models suggestions at block 724, code is revised based on the feedback. The code is tested at block 728, and if the code passes, the function is stored in a database at block 730.

If at block 714, a function is required, then the process proceeds to block 730, where it is determined whether the AI model has a suitable function accessible in a database.

If yes, the process proceeds to block 732, where the tasks are associated with the function. Then at block 734, the task is executed using the function. Then at block 736 it is determined whether the task was successful. If so, the process proceed to determine if the task was final. If the task was final, the process is completed. The process may be completed after receiving verification from the user the task was final at block 740. If the user indication received indicates the task was not final, then the process proceeds to ask the AI model for a task failure recovery strategy. The task is reevaluated at block 744, and the reevaluated task is stored in the database at block 746. The revaluated task may be executed as the process returns to block 734. If at block 736, the task was not successful, the AI model can be queried to determine guidance in resolving the task.

If at block 730, the AI model does not have a suitable task in the database, then a suitable task may be identified within an open source platform, such as GitHub and the like. In the example, if the task is identified in Github, at block 752, the library for the task may be fetched from the site at block 758. Also in the example, if the task is identified in the Python library, at block 754, the library for the task may be fetched from the site at block 760. In either event, the process proceeds to block 764, where the fetched data is analyzed to isolate classes and functions. The code is reviewed using the AI model at block 770, and the process proceeds to block 728, where the code is tested. If it passed, the code is stored in that database at block 730. If it does not pass, the method proceeds to block 724, and so forth as described. If at block 750 the suitable source is an external API, as illustrated at block 756, the API endpoint is identified. The process proceeds to block 766 where a request with an API key is sent. The API data is received at block 768, and the code is reviewed with the AI model at block 770. The process proceeds to block 728, where the code is tested. If it passed, the code is stored in that database at block 730. If it does not pass, the method proceeds to block 724, and so forth as described.

Having described an overview of some embodiments of the present technology, an example computing environment in which embodiments of the present technology may be implemented is described below in order to provide a general context for various aspects of the present technology. Referring now to FIG. 8 in particular, an example operating environment for implementing embodiments of the present technology is shown and designated generally as computing device 800. Computing device 800 is but one example of a suitable computing environment and is not intended to suggest any limitation as to the scope of use or functionality of the technology. Computing device 800 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules including routines, programs, objects, components, data structures, etc., refer to code that perform particular tasks or implement particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810, which directly or indirectly couples the following devices: memory 812, one or more processors 814, one or more presentation components 816, input/output (I/O) ports 818, input/output components 820, and illustrative power supply 822. Bus 810 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 8 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 8 and with reference to “computing device.”

Computing device 800 typically includes a variety of computer-readable media. Computer-readable media can be any available media that can be accessed by computing device 800 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 800. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 812 includes computer-storage media in the form of volatile or non-volatile memory. The memory may be removable, non-removable, or a combination thereof. Example hardware devices include solid-state memory, hard drives, optical-disc drives, etc. Computing device 800 includes one or more processors that read data from various entities, such as memory 812 or I/O components 820. Presentation component(s) 816 presents data indications to a user or other device. Example presentation components include a display device, speaker, printing component, vibrating component, etc.

I/O ports 818 allow computing device 800 to be logically coupled to other devices, including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 800. Computing device 800 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 800 may be equipped with accelerometers or gyroscopes that enable detection of motion. The output of the accelerometers or gyroscopes may be provided to the display of computing device 800 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher level software, such as application software; and any combination thereof. In this regard, components for generating new information or documents using a generative AI model, e.g., an LLM model, can manage resources and provide the described functionality. Any other variations and combinations thereof are contemplated within embodiments of the present technology.

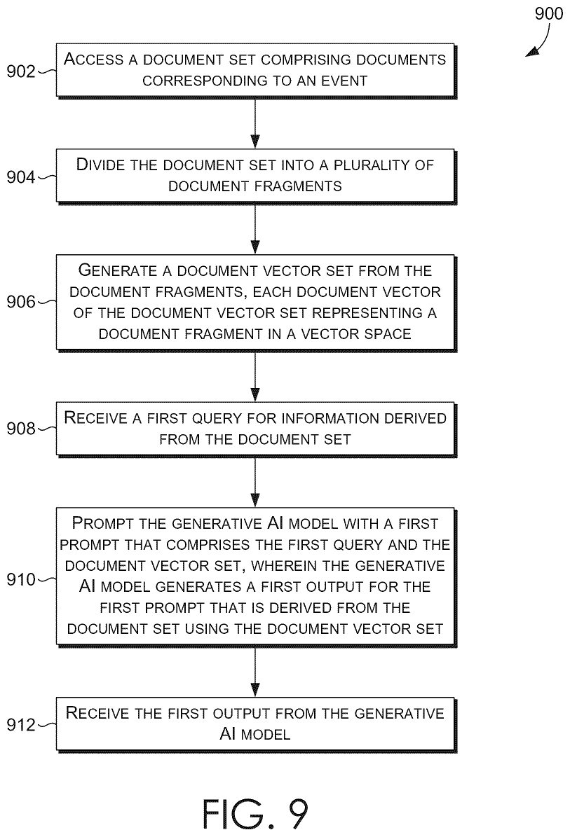

Turning now to FIG. 9, a block diagram is provided illustrating method 900. Each block of method 900 may comprise a computing process performed using any combination of hardware, firmware, or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few possibilities. Method 900 may be implemented in whole or in part by components of operating environment 100.

With continued reference to FIG. 9, in block 902, method 900 accesses a document set comprising documents corresponding to an event. In block 904, method 900 divides the document set into a plurality of document fragments. In block 906, method 900 generates a document vector set from the document fragments, each document vector of the document vector set representing a document fragment in a vector space. In block 908, method 900 receives a first query for information derived from the document set. In block 910, method 900 prompts the generative AI model with a first prompt that comprises the first query and the document vector set, wherein the generative AI model generates a first output for the first prompt that is derived from the document set using the document vector set. In block 912, method 900 receives the first output from the generative AI model.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving,” or “transmitting,” as facilitated by software or hardware-based buses, receivers, or transmitters, using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

What is claimed is:

1. A method performed by one or more processors, the method comprising:
accessing a document set comprising documents corresponding to an event;
dividing the document set into a plurality of document fragments;
generating a document vector set from the document fragments, each document vector of the document vector set representing a document fragment in a vector space;
receiving a first query for information derived from the document set;
prompting the generative AI model with a first prompt that comprises the first query and the document vector set, wherein the generative AI model generates a first output for the first prompt that is derived from the document set using the document vector set; and
receiving the first output from the generative AI model.

2. The method of claim 1, further comprising:
receiving a second query for additional information derived from the document set;
prompting the generative AI model with a second prompt, the second prompt comprising the second query, the identify of the provided document vector set, the first query, and the first output, wherein the generative AI model generates a second output for the second prompt, the second output is derived from the document set using the document vector set and generated with context provided by the first query and first output; and
receiving the second output from the generative AI model.

3. The method of claim 1, wherein division of the document set is based on a token limitation of the generative AI model.

4. The method of claim 1, wherein division of the document set is performed using a recursive character text splitter.

5. The method claim 1, further comprising:
accessing a pre-trained generative AI model;
fine-tuning the pre-trained generative AI model using a document corpus in a field corresponding to a field of the document set; and
providing the fine-tuned generative AI model as the generative AI model for receiving prompts.

6. The method claim 1, further comprising:
accessing a document template comprising fields, each field corresponding to a descriptor that describes an input to the field, wherein the first query to the generative AI model is based on a first descriptor for a first field of the document template; and
generating a filled document by inputting the first output of the generative AI model into the first field of the document template.

7. A system comprising:
at least one processor; and
one or more computer storage media storing instructions thereon that, when executed by the at least one processor, cause the processor to perform operations comprising:
accessing a document set comprising documents corresponding to an event;
dividing the document set into a plurality of document fragments;
generating a document vector set from the document fragments, each document vector of the document vector set representing a document fragment in a vector space;
receiving a first query for information derived from the document set;
prompting the generative AI model with a first prompt that comprises the first query and the document vector set, wherein the generative AI model generates a first output for the first prompt that is derived from the document set using the document vector set; and
receiving the first output from the generative AI model.

8. The system of claim 7, wherein the operations further comprise:
receiving a second query for additional information derived from the document set;
prompting the generative AI model with a second prompt, the second prompt comprising the second query, the identify of the provided document vector set, the first query, and the first output, wherein the generative AI model generates a second output for the second prompt, the second output is derived from the document set using the document vector set and generated with context provided by the first query and first output; and
receiving the second output from the generative AI model.

9. The system of claim 7, wherein division of the document set is based on a token limitation of the generative AI model.

10. The system of claim 7, wherein division of the document set is performed using a recursive character text splitter.

11. The system of claim 7, wherein the operations further comprise:
accessing a pre-trained generative AI model;
fine-tuning the pre-trained generative AI model using a document corpus in a field corresponding to a field of the document set; and
providing the fine-tuned generative AI model as the generative AI model for receiving prompts.

12. The system of claim 7, wherein the operations further comprise:
accessing a document template comprising fields, each field corresponding to a descriptor that describes an input to the field, wherein the first query to the generative AI model is based on a first descriptor for a first field of the document template; and
generating a filled document by inputting the first output of the generative AI model into the first field of the document template.

13. One or more computer storage media storing instructions thereon that, when executed by a processor, cause the processor to perform a method comprising:
accessing a document set comprising documents corresponding to an event;
dividing the document set into a plurality of document fragments;
generating a document vector set from the document fragments, each document vector of the document vector set representing a document fragment in a vector space;
receiving a first query for information derived from the document set;
prompting the generative AI model with a first prompt that comprises the first query and the document vector set, wherein the generative AI model generates a first output for the first prompt that is derived from the document set using the document vector set; and
receiving the first output from the generative AI model.

14. The media of claim 13, further comprising instructions for:
receiving a second query for additional information derived from the document set;
prompting the generative AI model with a second prompt, the second prompt comprising the second query, the identify of the provided document vector set, the first query, and the first output, wherein the generative AI model generates a second output for the second prompt, the second output is derived from the document set using the document vector set and generated with context provided by the first query and first output; and
receiving the second output from the generative AI model.

15. The media of claim 13, wherein division of the document set is based on a token limitation of the generative AI model.

16. The media of claim 13, wherein division of the document set is performed using a recursive character text splitter.

17. The media of claim 13, further comprising instructions for:
accessing a pre-trained generative AI model;
fine-tuning the pre-trained generative AI model using a document corpus in a field corresponding to a field of the document set; and
providing the fine-tuned generative AI model as the generative AI model for receiving prompts.

18. The media of claim 13, further comprising instructions for:
accessing a document template comprising fields, each field corresponding to a descriptor that describes an input to the field, wherein the first query to the generative AI model is based on a first descriptor for a first field of the document template; and
generating a filled document by inputting the first output of the generative AI model into the first field of the document template.
